(19) United States
(12) Patent Application Publication
(10) Pub. No.: US 2005/0004730 A1
(43) Pub. Date: Jan. 6, 2005

(54) Vehicle-rollover detecting apparatus and vehicle-rollover detecting method

(75) Inventors: Ryoutarou Suzuki, Tokyo (JP); Yuji Ariyoshi, Tokyo (JP); Masahiro Nakamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/880,465

(22) Filed: Jul. 1, 2004

(30) Foreign Application Priority Data
Jul. 3, 2003 (JP) 2003-191194

(51) Int. Cl. B60G 23/00

(52) U.S. Cl. 701/38; 280/735

(57) ABSTRACT

A vehicle-rollover detecting apparatus includes sensors for detecting the lateral acceleration, vertical acceleration and roll angular velocity of the vehicle; a section for calculating the roll angle of the vehicle by integrating the roll angular velocity; a section for performing the zero correction of the roll angle of the vehicle according to the lateral acceleration and roll angular velocity; a section for detecting the mode of the rollover from the composite acceleration of the lateral acceleration and vertical acceleration; a section for deciding a rollover detection threshold map of the vehicle in accordance with the mode of the rollover; a section for deciding the developing degree of the rollover from the composite acceleration; a section for correcting the threshold value of the map using the developing degree; and a section for deciding the occurrence of the rollover from the map whose threshold value is corrected.

### BACKGROUND OF THE INVENTION

1. Field of the Invention

The present invention relates to a vehicle-rollover detecting apparatus and a vehicle-rollover detecting method for detecting vehicle-rollover.

2. Description of Related Art

Conventionally, as one of the most commonly used rollover detecting methods, there is a method of carrying out the rollover detection on a two-dimensional map of the roll angle θ and roll angular velocity ω of a vehicle (see Relevant Reference 1, for example). However, the detecting method disclosed in the Relevant Reference 1, which uses the ω-θ two-dimensional map, has a problem of retarding the detection timing of the rollover when the roll angular velocity is very large or increases sharply. To solve the problem, methods are proposed which classify the developing type of the rollover in accordance with the magnitude of the acceleration detected by acceleration sensors (Y axis and/or Z axis), and use rollover detection threshold maps matching the individual developing types. These methods utilize the detection values of the Y axis sensor and Z axis sensor for detecting the rollover (see, Relevant References 2 and 3 for example).

Relevant Reference 1: Japanese patent application laid-open No. 7-164985/1995.

Relevant Reference 2: Japanese patent application laid-open No. 2001-83172.

Relevant Reference 3: Japanese patent application laid-open No. 2002-200951.

The methods described in the Relevant References 2 and 3, however, have a problem of being unable to detect the magnitude of the lateral acceleration accurately. This is because when the vehicle rolls, the detecting axes of the sensors also slant. In addition, even when it is assumed that the Y axis acceleration sensor detects the centrifugal force and the Z axis acceleration sensor detects the acceleration of gravity and the acceleration of the up-and-down movement, both the sensors detect the acceleration of gravity and the centrifugal force when the vehicle inclines. This presents a problem of making it difficult to associate the acceleration detected by each sensor to the rollover independently.

### SUMMARY OF THE INVENTION

The present invention is implemented to solve the foregoing problems. It is therefore an object of the present invention to provide a vehicle-rollover detecting apparatus and vehicle-rollover detecting method that can detect a vehicle-rollover quickly and accurately and has a simple configuration and general versatility. It is achieved by calculating the total acceleration by summing up a variety of acceleration components acting on the vehicle, by deciding possible modes of the rollover according to the direction and magnitude of the acceleration calculated, and by deciding the appropriate reference for making a rollover decision according to the mode.

According to one aspect of the present invention, there is provided a vehicle-rollover detecting apparatus including: a lateral acceleration detecting section for detecting acceleration in a lateral direction of a vehicle as lateral acceleration; a vertical acceleration detecting section for detecting acceleration in a vertical direction of the vehicle as vertical acceleration; a roll angular velocity detecting section for detecting rotational angular velocity about an axis in a longitudinal direction of the vehicle as roll angular velocity; a roll angle calculating section for calculating a roll angle of the vehicle by integrating the roll angular velocity; a roll angle zero correcting section for performing zero correction of the roll angle of the vehicle according to the lateral acceleration and the roll angular velocity; a rollover mode detecting section for detecting a mode of the rollover by combining the lateral acceleration with the vertical acceleration, and by using the composite acceleration; a rollover detection threshold map decision section for deciding a rollover detection threshold map of the vehicle in accordance with the mode of the rollover detected; a rollover developing degree decision section for deciding a developing degree of the rollover by combining the lateral acceleration with the vertical acceleration, and by using a magnitude of the composite acceleration; a map threshold correction section for correcting a threshold value of the rollover detection threshold map in accordance with the developing degree of the rollover decided; and a rollover occurrence decision section for detecting an occurrence of a rollover in accordance with the rollover detection threshold map whose threshold value is corrected by the map threshold correction section.

### BRIEF DESCRIPTION OF THE DRAWINGS

FIG. 1 is a functional block diagram showing a configuration of an embodiment 1 of a vehicle-rollover detecting apparatus in accordance with the present invention;

FIG. 2 is a flowchart illustrating the operation of the vehicle-rollover detecting apparatus of the embodiment 1 in accordance with the present invention;

FIGS. 3A and 3B are diagrams illustrating a rollover mode in the embodiment 1 in accordance with the present invention;

FIG. 4 is a diagram illustrating various rollover modes in the embodiment 1 in accordance with the present invention;

FIG. 5 is a diagram illustrating a rollover mode decision map in the embodiment 1 in accordance with the present invention; and

FIG. 6 is a diagram illustrating rollover detection threshold maps in the embodiment 1 in accordance with the present invention.

### DETAILED DESCRIPTION OF THE PREFERRED EMBODIMENTS

The embodiments in accordance with the present invention will now be described with reference to the accompanying drawings.

### Embodiment 1

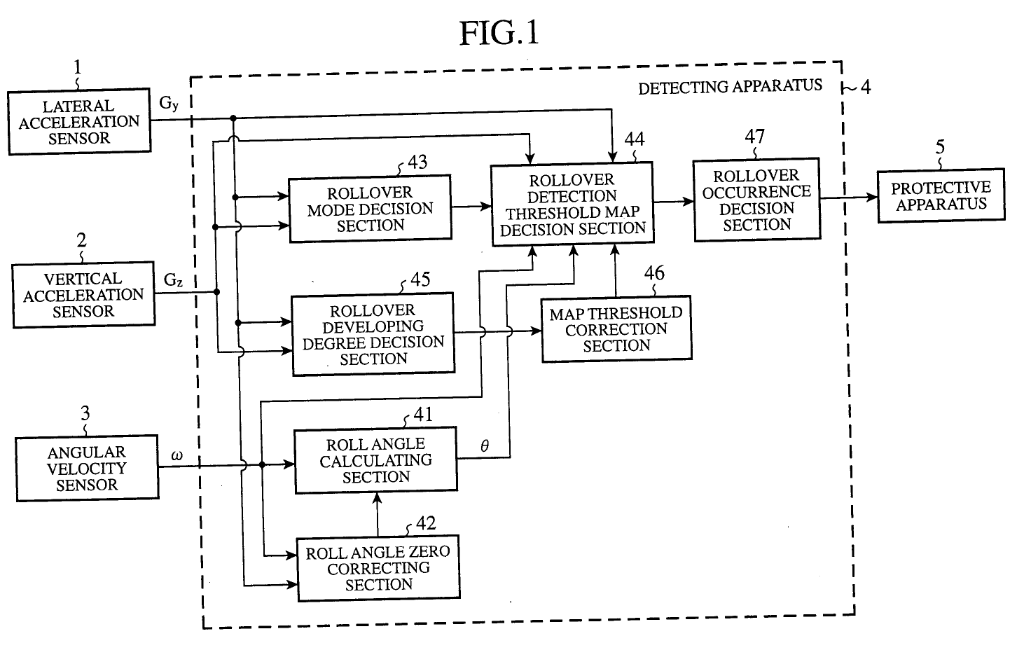

FIG. 1 is a functional block diagram showing a configuration of the embodiment 1 of a vehicle-rollover detecting apparatus in accordance with the present invention. In FIG. 1, a lateral acceleration sensor 1, a vertical acceleration sensor 2 and an angular velocity sensor 3 are provided at the input side of a detecting apparatus 4. The lateral acceleration sensor 1 functions as a lateral acceleration detecting section for detecting the acceleration in the lateral direction of the vehicle as the lateral acceleration. The vertical acceleration sensor 2 functions as a vertical acceleration detecting section for detecting the acceleration in the vertical direction of the vehicle as the vertical acceleration. The angular velocity sensor 3 functions as a roll angular velocity detecting section for detecting a rotational angular velocity (roll rate) about the axis in the longitudinal direction of the vehicle as the roll angular velocity.

The detecting apparatus 4 includes a roll angle calculating section 41, a roll angle zero correcting section 42, a rollover mode detecting section 43, a rollover developing degree decision section 45, a rollover detection threshold map decision section 44, a map threshold correction section 46, and a rollover occurrence decision section 47. The roll angle calculating section 41 calculates the roll angle of the vehicle by integrating the roll angular velocity fed from the angular velocity sensor 3. The roll angle zero correcting section 42 carries out the zero correction of the roll angle of the vehicle in accordance with the lateral acceleration from the lateral acceleration sensor 1 and the roll angular velocity from the angular velocity sensor 3. The rollover mode detecting section 43 detects the mode of the rollover according to the lateral acceleration from the lateral acceleration sensor 1 and the vertical acceleration from the vertical acceleration sensor 2. The rollover developing degree decision section 45 decides the developing degree of the rollover from the magnitude of the resultant of the lateral acceleration from the lateral acceleration sensor 1 and the vertical acceleration of the vertical acceleration sensor 2. The rollover detection threshold map decision section 44 decides the vehicle-rollover detection threshold map from two parameters out of the lateral acceleration, vertical acceleration, roll angular velocity, and roll angle of the vehicle in accordance with the mode of the rollover detected by the rollover mode detecting section 43. The map threshold correction section 46 corrects the threshold value of the rollover detection threshold map in the rollover detection threshold map decision section 44 according to the developing degree decided by the rollover developing degree decision section 45. The rollover occurrence decision section 47 decides the occurrence of the rollover from the relationship between the two parameters selected by the rollover detection threshold map decision section 44.

The rollover occurrence decision section 47 supplies the rollover decision output to an external protective apparatus 5 including a side airbag system as a start signal. In response to the start signal, the protective apparatus 5 expands the side airbag in the event of the rollover to protect the occupants on the driver's seat and passenger seat.

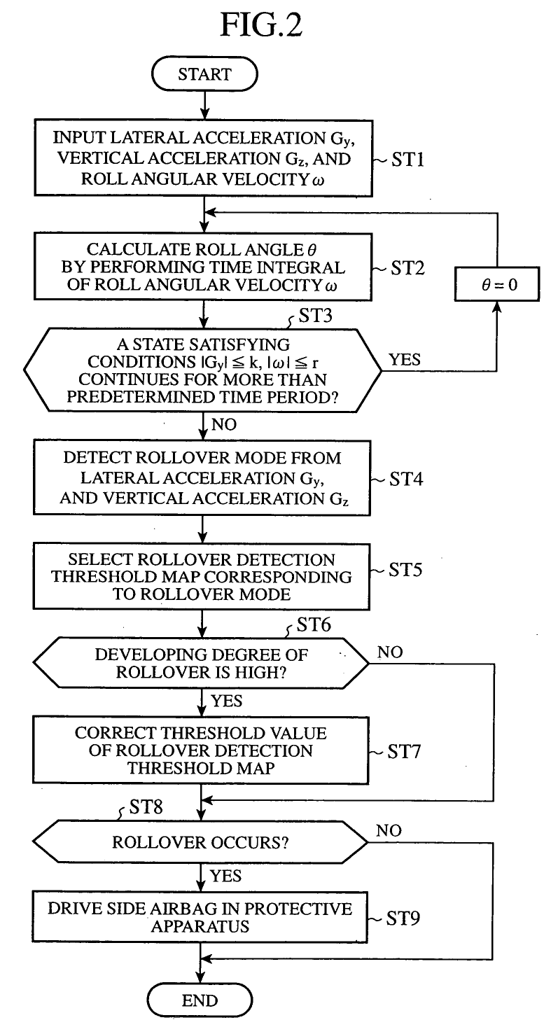

Next, the operation of the present embodiment 1 will be described with reference to FIGS. 2-6.

At step ST1 of FIG. 2, the detecting apparatus 4 is supplied with the lateral acceleration Gy of the vehicle detected by the lateral acceleration sensor 1, the vertical acceleration Gz of the vehicle detected by the vertical acceleration sensor 2, and the roll angular velocity ω about the axis in the longitudinal direction of the vehicle detected by the angular velocity sensor 3.

At step ST2, the roll angle calculating section 41 calculates the roll angle θ by performing the time integral of the roll angular velocity ω detected by the angular velocity sensor 3.

At the next step ST3, the roll angle zero correcting section 42 makes a decision as to whether a state satisfying |Gy|≦k and |ω|≦r continues for more than a predetermined time period, where k and r are a constant. When the state continues for more than the predetermined time period, the roll angle zero correcting section 42 makes a decision that the vehicle is in a stable level state without slant. Then, the roll angle zero correcting section 42 resets the roll angle θ of the vehicle, which is obtained by performing the time integral of the roll angular velocity ω by the roll angle calculating section 41, thereby carrying out the zero correction of the roll angle of the vehicle, followed by returning the processing to step ST2. In contrast with this, if the state satisfying the conditions |Gy|≦k and |ω|≦r discontinues within the predetermined time period at step ST3, this means that the vehicle is inclined and not in a stable level condition. Thus, at step ST4, the rollover mode detecting section 43 detects the mode of the rollover according to the lateral acceleration Gy detected by the lateral acceleration sensor 1 and the vertical acceleration Gz detected by the vertical acceleration sensor 2.

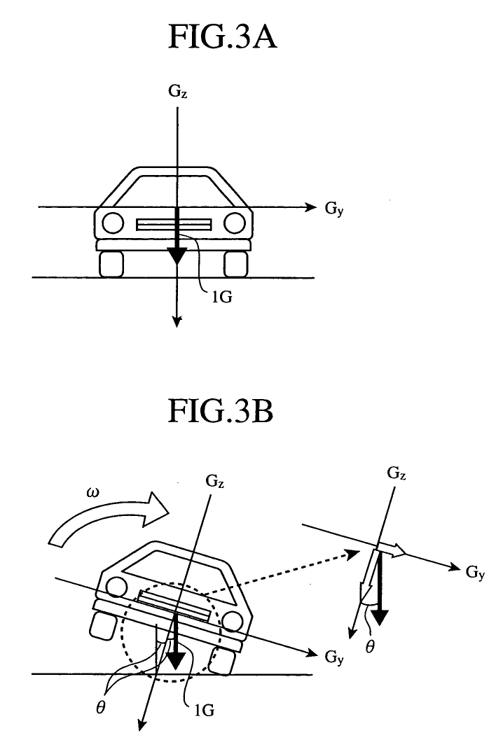

The mode of the rollover and a detecting method thereof will now be described with reference to FIGS. 3A-5.

Generally, the behavior of the vehicle at the rollover is complicated, and a variety of factors affect the behavior of the vehicle. First, FIG. 3A shows a state in which the vehicle is in a level condition, and FIG. 3B shows a state in which the vehicle is in a rollover condition. In these cases, the force and velocity produced concerning the vehicle will be defined. Assume that the roll angle (θ) indicates the rocking from side to side of the vehicle with respect to the road surface, the roll angular velocity (roll rate: ω) represents the rotational speed about the axis in the longitudinal direction of the vehicle, the lateral acceleration (Gy) represents the acceleration in the lateral direction of the vehicle, and the vertical acceleration (Gz) represents the acceleration in the vertical direction of the vehicle. In FIG. 3B, the broken arrow indicates the composite acceleration of the lateral acceleration (Gy) and the vertical acceleration (Gz).

In FIG. 3A, the lateral acceleration Gy, the acceleration along the Y axis detected by the lateral acceleration sensor 1, is zero (G), and the vertical acceleration Gz, the acceleration along the Z axis detected by the vertical acceleration sensor 2, is one (G), so that the resultant acceleration is 0+1=1. On the other hand, in FIG. 3B, the lateral acceleration Gy detected by the lateral acceleration sensor 1 is sin θ(G), and the vertical acceleration Gz detected by the vertical acceleration sensor 2 is cos θ (G), so that the composite acceleration is √sin² θ+cos² θ=1.

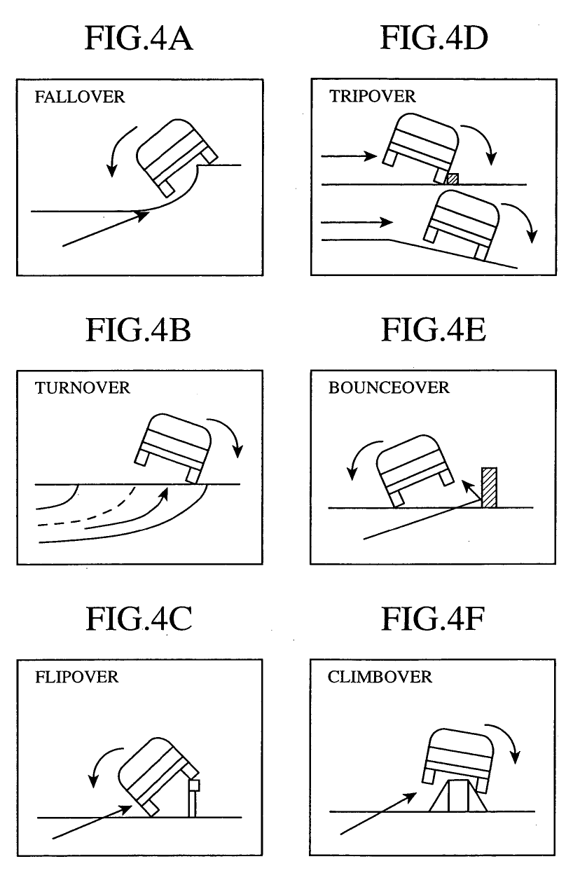

Next, referring to FIG. 4, the mode of the rollover is classified, and causes of occurrence and characteristics thereof will be described.

FIG. 4(a) illustrates a fallover that occurs in such a case as wheels on one side fall in a groove or the like during running, in which case the lateral acceleration Gy is small, and the roll angular velocity ω is large. FIG. 4(b) illustrates a turnover that occurs during hard cornering because of the friction of the tires on the road surface, in which case the lateral acceleration Gy is approximately proportional to the roll angle θ. FIG. 4(c) illustrates a flipover that occurs when the wheels on one side run onto an obstacle or side during running, in which case the lateral acceleration Gy is small and the roll angle θ is large throughout the rollover. FIG. 4(d) illustrates a tripover that occurs because of a skid or a collision with a curbstone, in which case the lateral acceleration Gy is large, the roll angle θ is small and the roll angular velocity ω is large at the beginning of the roll. FIG. 4(e) illustrates a bounceover that occurs because of a collision with an obstacle during running. FIG. 4(f) illustrates a climbover that occurs when the vehicle runs onto a protuberance, climbs it over and falls down. In this case, the lateral acceleration Gy is small.

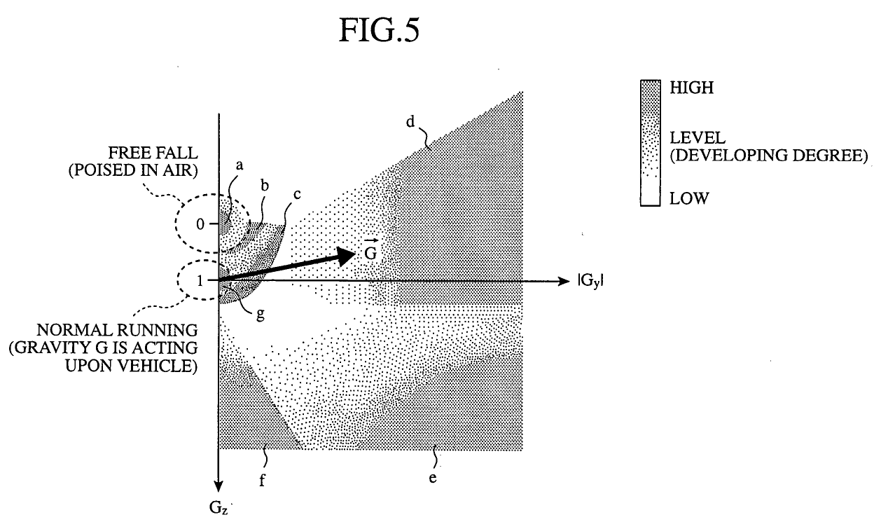

FIG. 5 illustrates a rollover mode detecting map used by the rollover mode detecting section 43. In FIG. 5, the thicker the shadows in the individual regions a-f, the higher the developing degree of the rollover.

In FIG. 5, the region a represents the fallover. In the normal case, the vehicle undergoes the acceleration of gravity so that the sum of the lateral and vertical components of the acceleration G is assumed to be equal to or greater than one G. Accordingly, if the vector sum of the lateral and vertical components of the acceleration detected is less than one G, a decision is made that a free fall (poised in the air) occurs. The developing degree of the rollover increases, as the magnitude of the vector sum is closer to zero.

The region b represents the turnover, in which case the lateral acceleration Gy detected by the lateral (Y axis) acceleration sensor 1 is approximately proportional to the roll angle θ calculated by the roll angle calculating section 41. According to the inclination of the sensor detecting axes due to the roll of the vehicle, the vertical acceleration (acceleration of gravity) Gz detected by the vertical (Z axis) acceleration sensor 2 is canceled out by the lateral acceleration Gy so that the acceleration Gz in the Z direction varies toward zero from one. Thus, the developing degree of the rollover increases, as the acceleration Gz is closer to zero G. As for the Y axis, it undergoes the acceleration of gravity and the gyration acceleration taking place in the same direction because of the roll of the vehicle so that the developing degree of the rollover increases as they increase.

The region c represents the flipover, in which case the wheels on one side are thrust up because of the flipover (corkscrew) so that the acceleration Gz in the Z direction (downward direction in FIG. 5) is detected. The vehicle is rolled by the thrust to be turned over. In this case, the acceleration detected by the sensor has also a Y axis component in accordance with the inclination of the vehicle. The region is defined such that the developing degree of the rollover increases with an increase in the magnitude of the acceleration in the Y and Z directions (in the outer region of the ellipse).

After the thrust-up wheels on one side separate from the road surface, the vehicle experience only the acceleration of gravity, thereby being nearly poised in the air. Thus, the acceleration of gravity detected is assumed to be small, so that the region is defined by a circle (ellipse) centered on the point zero.

The region d represents the tripover which occurs in a case where the wheel collides with a curbstone or the like during the skid. Even if the collision is trivial, the acceleration detected in the collision is much greater than that caused by the sway or gyration during the normal running. Thus, when the large acceleration is detected in the Y direction, a decision is made that the tripover takes place. The region d in FIG. 5 expands upward in the graph considering the fact that the vehicle usually rolls during the skid, and that the acceleration is also detected in the z direction when the vehicle undergoes the acceleration in the horizontal direction during the roll.

The region e represents the bounceover, in which case the vehicle experiences a collision in the lateral direction and can be turned over because of the shock and the swing back of the springs of the suspension. Compared with the tripover, although the direction of the shock due to the collision is the same, the direction of the roll and overturn is reversed in the bounceover. As for the region in the graph, it is defined such that it has large acceleration in the Y direction, and expands downward in the z direction (not necessarily symmetric with the tripover).

The region f represents the climbover that occurs when the bottom of the vehicle runs upon an obstacle. Considering it is a collision in the vertical direction, the region f in the climbover mode is defined when very large acceleration is detected in the Z direction, and the region f is widened considering the roll of the vehicle when it runs upon the obstacle.

The region g represents the normal running, in which the vehicle experiences the acceleration of gravity (one G).

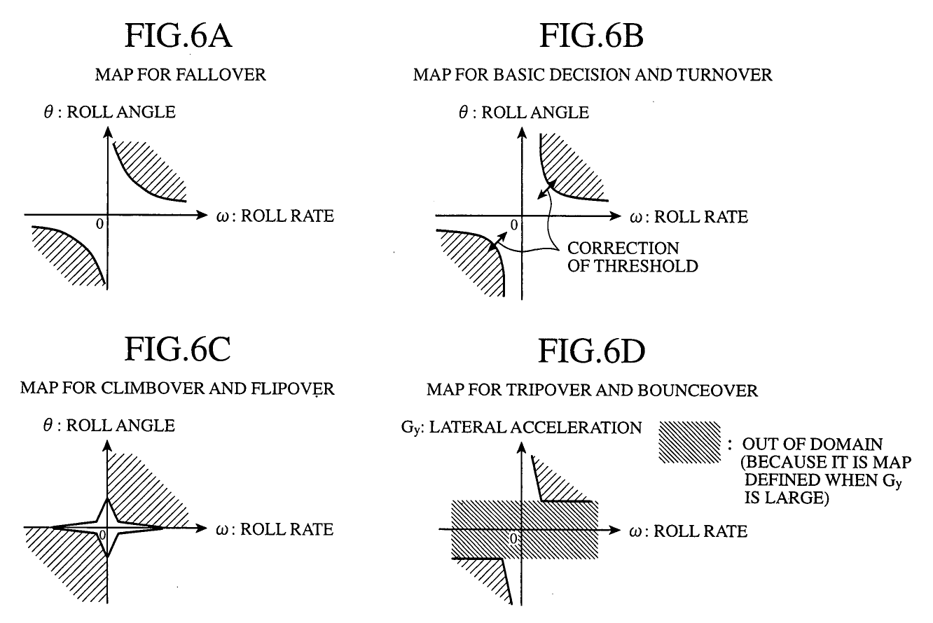

Once the rollover mode decision section 43 decides the mode of the rollover at step ST4, the rollover detection threshold map decision section 44 selects at step ST5 the rollover detection threshold map corresponding to the decided mode of the rollover as illustrated in FIG. 6. In other words, according to the detected mode of the rollover, the rollover detection threshold map decision section 44 selects the appropriate rollover threshold decision map. The rollover detection threshold maps are prestored in a storing section (now shown) in correspondence with the modes of the rollover.

In FIG. 6, FIG. 6(a) illustrates the map for the fallover corresponding to the region a of FIG. 5; and FIG. 6(b) illustrates the map for the turnover corresponding to the region b of FIG. 5, which is also a map for making a basic decision as to the normal running mode in the region g. FIG. 6(c) illustrates the map for the climbover/flipover corresponding to the flipover mode indicated by the region c and climbover mode indicated by the region f of FIG. 5; and FIG. 6(d) illustrates the map for the tripover/bounceover corresponding to the tripover mode indicated by the region d and bounceover mode indicated by the region e of FIG. 5. The shadowed portions in FIG. 6 represent the rollover occurrence decision regions. Next, at step ST6, the rollover developing degree decision section 45 combines the lateral acceleration with the vertical acceleration, and decides as to whether the developing degree of the rollover is large or not according to the magnitude. More specifically, the rollover developing degree decision section 45 calculates (|Gy|²+|Gz|²)^{1/2} by combining the two components of the acceleration, where |Gy| is the magnitude of the lateral acceleration and |Gz| is the magnitude of the vertical acceleration, and makes a decision that the developing degree of the rollover is higher as the total acceleration (composite acceleration) is larger. Accordingly, once a decision is made that the developing degree of the rollover is high at step ST6, the map threshold correction section 46 corrects the threshold value of the rollover detection threshold map selected by the rollover detection threshold map decision section 44 such that the threshold value is reduced as the developing degree of the rollover becomes greater at step ST7 (for example, see FIG. 6(b)). Thus, when the lateral acceleration Gy and the vertical acceleration Gz vary, and enters another region of FIG. 5, the threshold map used for the rollover decision is changed.

Subsequently, the rollover occurrence decision section 47 makes a decision as to whether the rollover occurs or not at step ST8. If the rollover does not occur, the processing is returned to step ST1 to repeat the foregoing operation, whereas if it occurs, the rollover occurrence decision section 47 drives the side airbag in the protective apparatus 5 at step ST9.

The reference for making the rollover decision by the rollover occurrence decision section 47 can be expressed as follows.
fi(α,β)≧0 for i:a-g (1)
where α and β are two of the four parameters Gy, Gz, ω, and θ, and a-g designates the individual regions in FIG. 5.

In addition, in the present embodiment 1, the developing degree of the rollover is set for each mode of the rollover such that it basically increases as the magnitude of the vector G (the vector sum of the lateral acceleration Gy and the vertical acceleration Gz) increases (as the shadowed portions of the individual regions a-f in FIG. 5 become thick). Accordingly, the rollover decision reference can be expressed as follows.
fi(α−sia,β−tia) (2)
where a is the magnitude of the vector G, i is a variable representing the regions a-f of FIG. 5, and si and ti are constants determined in accordance with the modes of the rollover.

Therefore, the rollover occurrence decision section 47 makes a decision that the rollover occurs when the parameters α and β detected by the sensors (two of the four parameters consisting of the acceleration components in the Y and Z directions and the roll rate and roll angle) satisfy the foregoing expression (2).

As described above, the present embodiment 1 combines the acceleration components in the Y and Z directions detected in the vehicle, that is, the lateral acceleration and the vertical acceleration, into one vector, and decides the mode of the rollover according to the direction and magnitude of the vector. As a result, the present embodiment 1 can detect the mode of the rollover accurately regardless of the inclination of the vehicle. In contrast with this, the conventional system considers the acceleration in only the Y or Z direction, or in the Y and Z directions independently. Thus, the conventional system cannot make effective use of these parameters for deciding the mode of the rollover, or can have different detection values depending on the inclination of the vehicle even if the acceleration is the same in the direction and magnitude.

In addition, since the present embodiment 1 employs the Y and Z axis sensors, that is, the lateral acceleration sensor and the vertical acceleration sensor, and handles a variety of components of the acceleration the vehicle experiences by combining them into one vector, it can consider the acceleration components in all the directions by two parameters of the direction and magnitude of the vector. As a result, the present embodiment 1 is simpler and has greater versatility than a system handling the acceleration components detected in the Y and Z axes independently, and can contribute quick and accurate decision. In addition, it offers an advantage that the magnitude of the acceleration obtained by the composition is free from the inclination of the vehicle.

Embodiment 2

Although the foregoing embodiment 1 detects the acceleration the vehicle experiences using the lateral acceleration sensor and vertical acceleration sensor, any combinations of the sensors other than these sensors are possible as long as they can detect the acceleration components in all the directions causing the roll of the vehicle. In addition, it is not necessary to mount the sensors along the Y and Z axes of the vehicle.

As for the two-dimensional maps prepared for selecting the rollover detection threshold map appropriate for each mode of the rollover, they can change the parameters used for the rollover such as varying the shapes of the rollover decision regions on the ω-θ map, or can employ the map other than the ω-θ map such as an ω-lateral acceleration map.

Furthermore, as for the rollover mode decision map, its classification of the modes of the rollover, the areas and boundaries of the modes are not limited to those of FIG. 5.

Moreover, although the foregoing embodiment 1 employs the lateral axis and vertical axis of the vehicle as the reference of the directions of the acceleration detected, this is not essential. For example, the rollover mode decision map can be formed by combining the detecting section of the inclination angle with respect to the road surface with the detecting section of the roll angle of the vehicle, and by defining the direction of the acceleration at the direction with respect to the horizontal road surface.

In this way, the present embodiment 2 can achieve the same advantages as the foregoing embodiment 1. In addition, the present embodiment 2 can cope with the rollover decision of a variety of modes, thereby being able to provide the general versatility to the decision method.

1. A vehicle-rollover detecting apparatus comprising:
a lateral acceleration detecting section for detecting acceleration in a lateral direction of a vehicle as lateral acceleration;
a vertical acceleration detecting section for detecting acceleration in a vertical direction of the vehicle as vertical acceleration;
a roll angular velocity detecting section for detecting rotational angular velocity about an axis in a longitudinal direction of the vehicle as roll angular velocity;
a roll angle calculating section for calculating a roll angle of the vehicle by integrating the roll angular velocity detected by said roll angular velocity detecting section;
a roll angle zero correcting section for performing zero correction of the roll angle of the vehicle according to the lateral acceleration detected by said lateral acceleration detecting section and the roll angular velocity detected by said roll angular velocity detecting section;
a rollover mode detecting section for detecting a mode of the rollover by combining the lateral acceleration detected by said lateral acceleration detecting section with the vertical acceleration detected by said vertical acceleration detecting section and by using the composite acceleration;
a rollover detection threshold map decision section for deciding a rollover detection threshold map of the vehicle in accordance with the mode of the rollover detected by said rollover mode detecting section;
a rollover developing degree decision section for deciding a developing degree of the rollover by combining the lateral acceleration detected by said lateral acceleration detecting section with the vertical acceleration detected by said vertical acceleration detecting section, and by using a magnitude of the composite acceleration;
a map threshold correction section for correcting a threshold value of the rollover detection threshold map in accordance with the developing degree of the rollover decided by said rollover developing degree decision section; and
a rollover occurrence decision section for detecting an occurrence of a rollover in accordance with the rollover detection threshold map whose threshold value is corrected by said map threshold correction section.

2. The vehicle-rollover detecting apparatus according to claim 1, wherein said rollover mode detecting section detects the mode of the rollover from the direction and magnitude of the composite acceleration.

3. The vehicle-rollover detecting apparatus according to claim 1, wherein said rollover detection threshold map decision section decides the rollover detection threshold map of the vehicle in accordance with relationship between two parameters selected from the lateral acceleration, vertical acceleration, roll angular velocity and vehicle-roll angle according to the mode of the rollover detected by said rollover mode detecting section.

4. The vehicle-rollover detecting apparatus according to claim 3, wherein said rollover occurrence decision section decides an occurrence of a rollover in accordance with the relationship between the two parameters selected.

5. The vehicle-rollover detecting apparatus according to claim 1, wherein said rollover mode detecting section combines the lateral acceleration detected by said lateral acceleration detecting section with the vertical acceleration detected by said vertical acceleration detecting section by one of a vector sum and an arithmetic sum.

6. The vehicle-rollover detecting apparatus according to claim 1, wherein said rollover mode detecting section includes a rollover mode decision map consisting of a two-dimensional map in which the rollover is classified into a tripover, turnover, flipover, bounceover, climbover, and fallover, and detects the mode of the rollover using the rollover mode decision map according to the composite acceleration of the lateral acceleration and vertical acceleration which are detected normally.

7. A vehicle-rollover detecting method comprising the steps of:
detecting acceleration in a lateral direction of a vehicle, acceleration in a vertical direction of the vehicle, and rotational angular velocity about an axis in a longitudinal direction of the vehicle as lateral acceleration, vertical acceleration, and roll angular velocity;
calculating a roll angle of the vehicle by integrating the roll angular velocity;
carrying out zero correction of the roll angle of the vehicle when the lateral acceleration and the roll angular velocity continue a state in which they are each equal to or less than a specified value for more than a predetermined time period;
detecting a mode of a rollover by combining the lateral acceleration with the vertical acceleration, ad by using the direction of the composite acceleration;
deciding a rollover detection threshold map of the vehicle in accordance with the mode of the rollover;
deciding a developing degree of the rollover by combining the lateral acceleration with the vertical acceleration, and by using the magnitude of the composite acceleration;
correcting the threshold value of the rollover detection threshold map such that it becomes small with an increase in the developing degree; and
deciding an occurrence of the rollover according to the rollover detection threshold map whose threshold value is corrected.

8. The vehicle-rollover detecting method according to claim 7, wherein the acceleration the vehicle experiences in a plane whose normal is a roll axis of the vehicle is detected using the lateral acceleration and the vertical acceleration.
